(19) United States
(12) Patent Application Publication
(10) Pub. No.: US 2005/0220534 A1
(43) Pub. Date: Oct. 6, 2005

(54) Mounting device

(76) Inventor: James R. Ober, Manheim, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/817,662

(22) Filed: Apr. 2, 2004

(51) Int. Cl. F16B 7/04; F16B 2/06

(52) U.S. Cl. 403/370; 403/371

(57) ABSTRACT

A mounting device for coaxially anchoring an elongated element upon a rotary shaft. The device fits between the interior bore of the elongated element and the cylindrical surface of the shaft and is effective to position the element at any desired position longitudinally of the shaft and at any angular position circumferentially of the shaft. The device has inner and outer sleeves, the mating surfaces of which are similarly tapered so that relative axial displacement of the sleeves effects contraction of the interior bore of the inner sleeve without effecting expansion of the external surface of the mounting device. Rotation of a threaded nut at one end of the device effects the relative axial displacement of the inner and outer sleeves to tighten the mounting device.

### FIELD OF THE INVENTION

The present invention relates to a mounting device for mounting a elongated element upon a shaft. In particular, the device of the present invention provides an improved mounting device for mounting elongated elements on a shaft permitting infinitely-variable adjustment of the elongated element on the shaft, both axially of the shaft and circumferentially thereof, and maintaining the elongated element at a fixed, axial position after mounting on the shaft.

### BACKGROUND OF THE INVENTION

A variety of devices have been used to mount machine elements onto a shaft. For instance, in certain applications it may be necessary to mount an elongated cylindrical element coaxially on the shaft. One such application is the mounting of a paper core onto a shaft. The paper core is an elongated roll of paper, typically having a cardboard core. One way of mounting a paper core onto a shaft utilizes cones that are threaded onto the shaft. However, such a system is overly complicated, requiring threads along the length of the shaft and keyways to lock the cone in place.

### SUMMARY OF THE INVENTION

In accordance with the present invention, a mounting device is provided that is easy to use. The device can be tightened by simply tightening a single locking ring to effect frictional engagement. The locking ring can also operate to positively release the frictional engagement produced by tightening the nut. Furthermore, the design of the present unit is of simple construction and is inexpensive to manufacture.

The present mounting device also solves the difficulty of maintaining the elongated element at a fixed position. Once mounted, the device retains the elongated element at a fixed, axial position relative to the shaft.

The mounting device includes an outer sleeve for engaging the elongated element, an inner sleeve for engaging the shaft and a locking ring for displacing the inner sleeve relative to the outer sleeve. In one embodiment, the outer sleeve includes an outer engagement surface that is configured to engage the elongated element to be mounted onto the shaft. The outer sleeve also includes a bore having a tapered surface. The inner sleeve includes an outer surface having a tapered surface that cooperates with the tapered internal surface of the outer sleeve to create a wedging effect when the outer sleeve is displaced relative to the inner sleeve in a first direction. The inner sleeve also includes a bore that is configured to cooperate with the shaft.

The locking ring is operable to displace the inner sleeve relative to the outer sleeve to tighten the device onto the shaft. More specifically, the locking ring includes a threaded portion that cooperates with a threaded portion on either the inner sleeve or the outer sleeve. In this way, rotating the locking ring in a first direction operates to displace the threaded sleeve relative to the locking ring, which in turn displaces the threaded sleeve relative to the other sleeve. Upon displacement of the inner sleeve relative to the outer sleeve, the tapered internal surface of the outer sleeve cooperates with the tapered outer surface of the inner sleeve to tighten the inner sleeve onto the shaft. However, preferably, the outer sleeve is formed of walls that are substantially rigid to impede expansion of the outer sleeve when the device is tightened.

A method for mounting an elongated element onto a shaft is also provided. The method includes the steps of positioning a first mounting device onto a shaft and positioning a second mounting device onto the shaft spaced apart from the first mounting device. The elongated element is positioned between the two mounting devices so that the first mounting device engages a first end of the elongated element and the second mounting device engages a second end of the elongated element. The first and second mounting devices each include inner and outer sleeves and a threaded locking ring. The first mounting device is tightened by turning the first locking ring, which displaces the inner sleeve relative to the outer sleeve to contract the inner sleeve, thereby providing a positive engagement between the inner sleeve and the shaft. Similarly, the second mounting device is then tightened by turning the second locking ring to affect relative displacement of the inner and outer sleeves of the second mounting device.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1 is a perspective view, partially broken away, of a mounting device;

FIG. 2 is a side elevational view, partially broken away, of a system utilizing the mounting device of FIG. 1;

FIG. 3 is an exploded perspective view of the mounting device illustrated in FIG. 1;

FIG. 4 is a cross-sectional view of the mounting device illustrated in FIG. 1; and

FIG. 5 is a perspective view of the mounting device of FIG. 1.

### DETAILED DESCRIPTION OF THE PREFERRED EMBODIMENTS

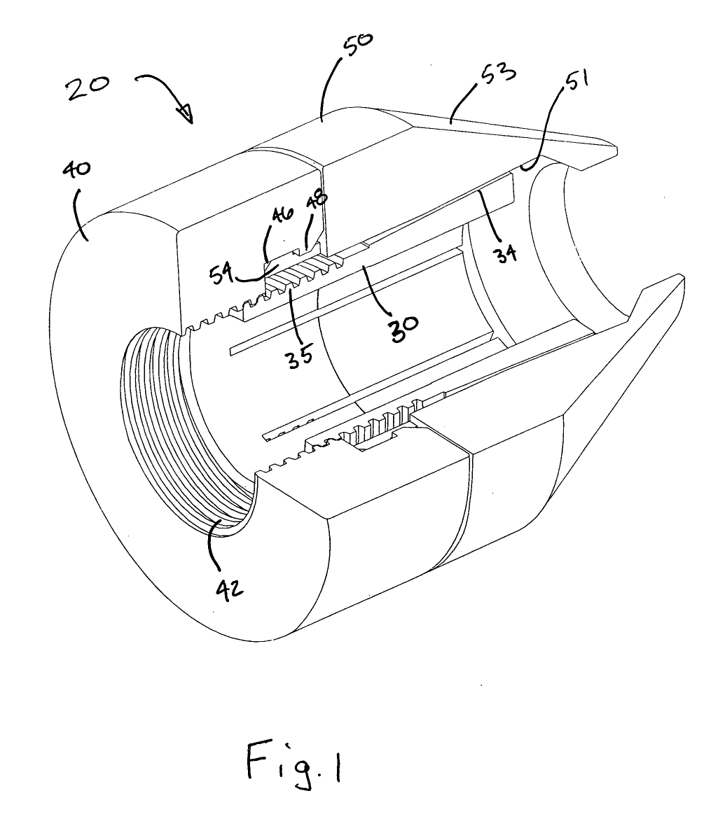

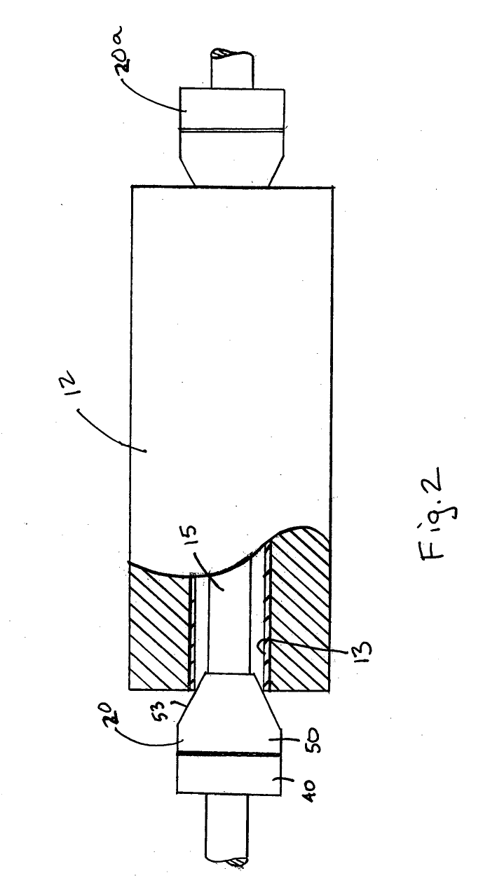

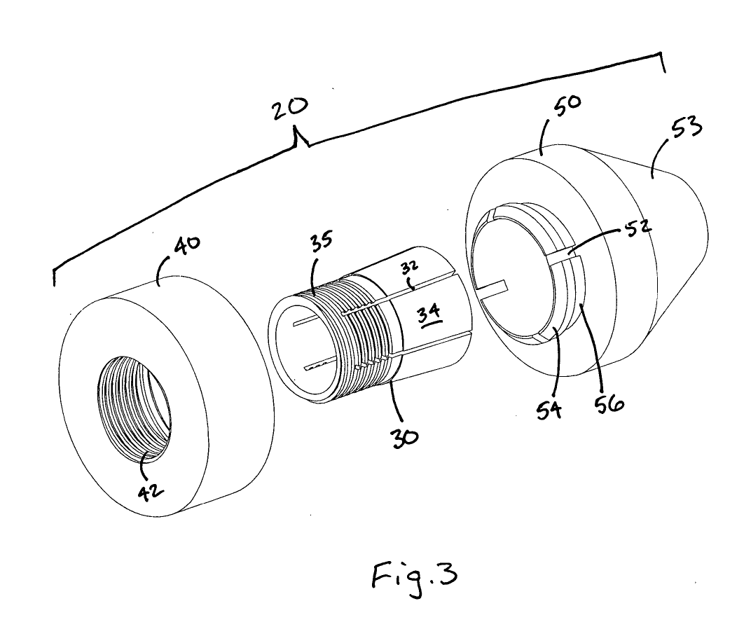

Referring now to the drawings and to FIGS. 1-2, specifically, a mounting device is designated generally 20. The mounting device is operable to position and support a elongated element 12 on a rotatable element, such as a cylindrical shaft 15. In one embodiment, the mounting device 20 supports a first end of the elongated element 12, while a second mounting device 20a supports the second end of the elongated element, as shown in FIG. 2. In this way the pair of mounting devices 20, 20a are operable to mount the elongated element 12 onto the shaft 15.

The mounting device 20 is particularly useful for mounting elongated cylindrical elements, such as paper cores 12 onto a shaft. The paper core comprises a roll of sheet paper. The paper core has a central bore for mounting onto a shaft. The paper core may be rolled onto a core element, such as a cardboard sleeve to form the bore. However, the paper core may simply be rolled onto itself so that the innermost convolution of paper forms the central bore for the paper core. As discussed further below, in one embodiment the paper core 12 is mounted onto a shaft 15 using a pair of mounting devices 20, 20a. The paper core is entrained between the two mounting devices to prevent axial displacement of the paper core relative to the shaft, while allowing the paper core to readily rotate relative to the shaft.

In the following discussion, the mounting device 20 is discussed in connection with a paper core. However, the mounting device can be used in connection with a variety of elements being mounted onto a shaft. By way of example, the mounting device can be used in connection with other types of rolled goods, such as rolled fabric.

Turning now to FIGS. 1, 2, 4, the details of the mounting device will be described in greater detail. The mounting device 20 includes an inner sleeve 30, an outer sleeve 50 and a locking ring 40. The inner sleeve 30 has an inner bore that is configured to cooperate with the shaft 15. In addition, the inner sleeve is radially deformable so that the inner sleeve can contract to frictionally engage the shaft. The outer sleeve 50 overlies the inner sleeve 30, and it is substantially rigid radially. The outer sleeve has an engagement surface that is configured to cooperate with the inner bore of the paper core 12 to position and support the paper core on the shaft 15. The mounting device is tightened or loosened by turning the locking ring 40.

Turning now to FIG. 1, the details of the mounting device 20 will be described in greater detail. The external surface of the inner sleeve 30 is formed to cooperate with the inner surface of the outer sleeve. Specifically, the forward end of the inner sleeve has a frustoconical tapered external surface 34. The frustoconical surface 34 is configured so that the major diameter is adjacent the forward edge of the inner sleeve and the minor diameter is spaced rearwardly from the forward edge. However, in certain applications, it may be desirable to have the minor diameter of the frustoconical surface adjacent the forward end and the major diameter spaced rearwardly therefrom. The external surface of the sleeve also includes an externally threaded portion 35 rearward of the frustoconical portion.

The inner sleeve 30 is tubular in form having an internal bore that cooperates with the external surface of the shaft 15. Specifically, if the external surface of the shaft is tapered or frustoconical, the internal surface of the inner sleeve has a cooperating tapered or frustoconical surface. In the present instance, the shaft is cylindrical, and the inner sleeve 30 has a cylindrical bore with a diameter that corresponds to the diameter of the shaft 15. Preferably, the bore of the inner sleeve is slightly greater in diameter than the shaft 15 to permit free sliding movement of the inner sleeve 30 on the shaft 15 both axially and circumferentially.

As discussed further below, the inner sleeve engages the shaft 15 by contracting so that the inner sleeve grips or clamps down onto the shaft. For this purpose, the inner sleeve 30 is formed into a plurality of segments by slots 32 that extend longitudinally through the sleeve from the forward end. The slots 32 allow radial deflection of the inner sleeve as the mounting device is tightened or released. Preferably, the slots terminate along a line spaced inwardly from the rearward end of the inner sleeve 30. In this way, the free end portion of the threaded end of the inner sleeve 30 is an unsplit solid continuous ring portion. This solid portion of the inner sleeve provides greater thread strength and improved threaded engagement with the locking ring 40, relative to a sleeve that is split along the entire axial length. In the present instance, the inner sleeve is provided with six equally spaced slots approximately 5/64″ in width. It will be recognized, however, that the number of slots, as well as the width, length and spacing of the slots can be varied to achieve the desired flexibility.

The inner sleeve 30 is adapted to fit within the outer sleeve 50, which is a unitary sleeve. The outer surface of the outer sleeve 50 has an engaging surface 53 that is configured to cooperate with an elongated element 12, such as the paper core discussed above. More specifically, the engaging surface is configured to cooperate with the internal bore 13 of the paper core 12. The engaging surface may be configured to match the internal bore of the paper core 12. However, in certain applications it may be desirable to have the two surfaces cooperate, without matching. For instance, as shown in FIG. 2, the engaging surface 53 of the outer sleeve is a generally frustoconical surface, and the internal bore of the paper core is generally cylindrical.

In the present embodiment, the outer sleeve 50 is substantially rigid to impede significant radial expansion or contraction when the device is tightened or loosened. For instance, unlike the inner sleeve, the outer sleeve does not include one or more slots through the outer sleeve. Instead, the walls of the outer sleeve are substantially solid. There may be recesses, slots or other features in the outer sleeve, however, such features should be configured so that such features do not weaken the walls of the outer sleeve to the point that the outer sleeve substantially deforms in a radial direction when the device is tightened. Alternatively, the outer sleeve 50 may include a plurality of axial slots through the engaging surface 53. In this way, when the device 20 is tightened, the engaging surface 53 expands radially outwardly to engage the bore 13 of the paper core 12.

In the present embodiment, the engaging surface 53 of the outer sleeve is frustoconical. The minor diameter of the frustoconical surface is adjacent the forward end of the outer sleeve 50 and the major diameter is spaced rearwardly. In other words, the largest diameter of the frustoconical surface 53 is located intermediate the ends of the outer sleeve and the surface tapers inwardly as the surface extends toward the forward end of the outer sleeve. In addition, preferably the minor diameter of the engaging surface is smaller than the diameter of the bore 13 of the paper core 12, but the major diameter of the outer sleeve is larger than the bore of the paper core. Further, preferably, the major diameter of the engaging surface is larger than the bore of the paper core.

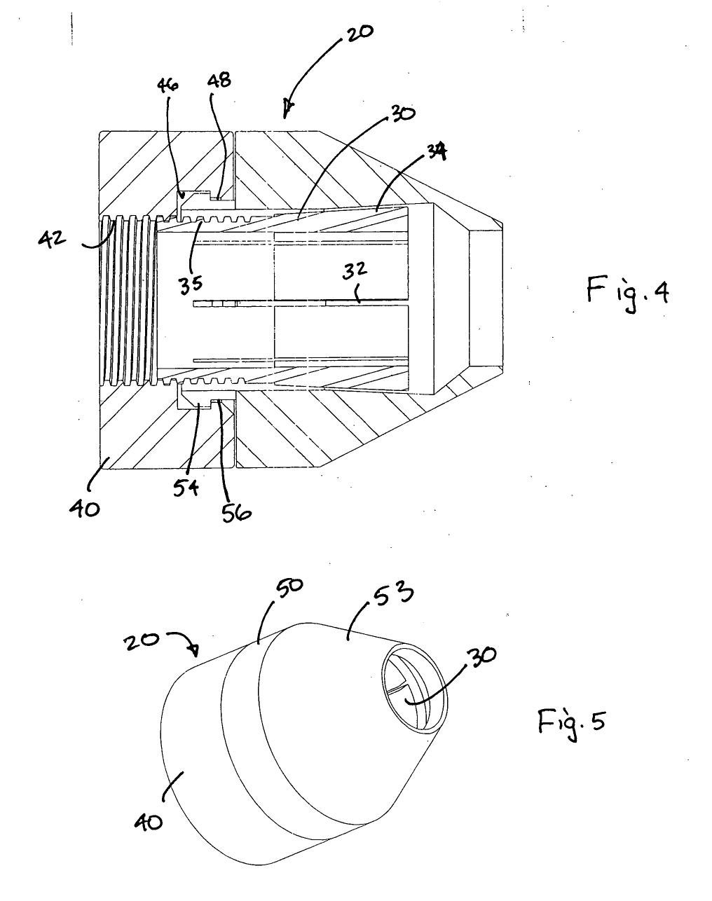

As shown in FIGS. 1, 4, the inner surface of the outer sleeve 50 is configured to cooperate with the external surface of the inner sleeve to contract the inner sleeve. Accordingly, the internal surface of the outer sleeve has a reduced diameter portion that is smaller in diameter than the major diameter of the frustoconical portion 34 of the inner sleeve 30. In the embodiment shown in FIG. 1, the inner and outer sleeves have mating tapered surfaces that cooperate to wedge against one another to contract the inner sleeve inwardly. More specifically, the inner surface of the outer sleeve 50 tapers toward the forward end at the same angle of taper as the frustoconical portion 34 of the inner sleeve 30. In this way, when the inner sleeve 30 is displaced rearwardly relative to the outer sleeve 50 (i.e. from left to right in FIG. 4), the confronting tapered surfaces of the inner and outer sleeves cooperate to contract the internal cylindrical surface of the inner sleeve 30. However, the walls of the outer sleeve are rigid enough to impede expansion in response to the interaction of the cooperating tapered surfaces that causes the inner sleeve to contract. Accordingly, in the embodiment illustrated in FIG. 4, tightening the mounting device to the shaft does not expand the outer sleeve into frictional engagement with the paper core 12.

Referring to FIG. 4, the outer sleeve 50 also comprises a connector or interlock for locking the outer sleeve together with the locking ring 40 to substantially impede axial displacement of the outer sleeve relative to the locking ring, while allowing rotation of the locking ring relative to the outer sleeve. The interlock can be formed in various configurations. For instance, a circumferential flange 54 projects away from the rearward end of the outer sleeve. A circumferential groove 56 extends about the outer surface of the outer sleeve 50 adjacent the flange 54. As discussed further below, the locking ring 40 engages the groove 56 to connect the locking ring to the outer sleeve 50.

The outer sleeve 50 is displaced relative to the inner sleeve 30 by the locking ring 40. To this end, as illustrated in FIGS. 1, 4, the locking ring 40 has internal threads 42 that threadedly engage the threads 35 of the inner sleeve 30. Rotating the locking ring 40 axially displaces the inner sleeve relative to the locking ring. Accordingly, since the outer sleeve 50 is connected to the locking ring, the inner sleeve is displaced relative to the outer sleeve as the locking ring is rotated.

The locking ring 40 has an internal bore that is larger than the diameter of the shaft 15. In addition, preferably the outer surface of the locking ring has a textured surface, such as knurling to provide a slip resistant surface that can be readily tightened by hand. Alternatively, the locking ring may be configured to cooperate with a tool for tightening the locking ring. For instance, the locking ring may include flat surfaces for engaging the locking ring with a wrench.

As discussed above, the locking ring is connected to the outer sleeve to impede substantial axial displacement between the locking ring and the outer sleeve. To provide a connection between the locking ring 40 and the outer sleeve 50, the locking ring is provided with an internal circumferential flange 48 that extends radially inwardly, and an annular groove 46 adjacent the flange. Preferably, the forward and rearward sidewalls of the groove 46 are substantially perpendicular to the common axis of the assembly. The internal locking ring flange 48 and annular groove 46 cooperate with the external flange 54 and circumferential groove 56 of the outer sleeve.

Specifically, the internal flange 48 of the locking ring engages the circumferential groove 56 of the outer sleeve, and the external flange 54 of the outer sleeve engages the annular groove 46 of the locking ring. Accordingly, the internal flange 48 of the locking ring has a width slightly less than the width of the external groove 56 of the outer sleeve, and the external flange 54 of the outer sleeve has a width slightly less than the width of the annular groove 46 of the locking ring. In this way, the rearward face of the external locking ring flange 48 confronts the rearward face of the circumferential groove 56 of the outer sleeve effecting rearward axial force on the outer sleeve 50 when the locking ring is rotated to drive the inner sleeve forwardly relative to the locking ring. Similarly, the forward face of the external locking ring flange 48 confronts the forward face of the circumferential groove 56 of the outer sleeve, and the rearward face of the circumferential flange 54 of the outer sleeve confronts the rearward face of the annular groove around the locking ring 40 effecting forceful forward axial force on the outer sleeve when the locking ring is rotated to drive the inner sleeve rearwardly relative to the locking ring.

The inner diameter of the internal flange of the locking ring is smaller than the outer diameter of the external flange on the outer sleeve, and the internal flange on the locking ring passes over the outer sleeve flange to connect the outer sleeve to the locking ring. Therefore, to connect the outer sleeve 50 to the locking ring 40 the connector of the outer sleeve is sufficiently flexible to contract inwardly allowing the locking ring to be displaced over the connector. Accordingly, the connector of the outer sleeve 50 is formed into a plurality of segments by means of slots 52 that extend axially longitudinally of the sleeve from the rearward end.

The mounting device 20 is assembled as follows. The locking ring 40 is threaded onto the inner sleeve 30. The outer sleeve 50 is connected to the locking ring 40 by sliding the outer sleeve over the inner sleeve 30 until the external flange 55 on the outer sleeve engages the internal flange 48 of the locking ring. Because the outer sleeve slides over the inner sleeve during assembly, preferably the locking ring is threaded onto the inner sleeve a sufficient distance so that the mating tapered surfaces 34, 51 of the inner and outer sleeves do not engage each other during assembly.

After sliding the outer sleeve 50 over the inner sleeve 30, the outer sleeve is connected to the locking ring 40 by driving the outer sleeve over the locking ring as follows. As the outer sleeve engages the locking ring, the connector of the outer sleeve flexes and contracts radially inwardly within the locking ring flange 48. To facilitate the radial contraction, the rearward face of the external flange 54 of the outer sleeve is chamfered as illustrated in FIGS. 1, 4. The outer sleeve is displaced rearwardly relative to the locking ring until the external flange 54 of the outer sleeve is displaced past the internal locking ring flange 48. The outer sleeve then resiliently expands so that the external flange 54 of the outer sleeve engages the annular groove 46 in the locking ring, and the internal locking ring flange 48 engages the circumferential groove 56 in the outer sleeve. In this way, the outer sleeve 50 is captively entrained by the locking ring 40.

The mounting device has been described as having an interlock in which the connector on the outer sleeve 50 flexes to resiliently contract within the locking ring 40. Alternatively, the locking ring may be configured to resiliently flex outwardly, so that the locking ring expands outwardly over the outer sleeve connector and then snaps into the circumferential groove on the outer sleeve. Further still, although the outer sleeve 50 has been described as having an external flange 54 that connects within the locking ring 40, the outer sleeve and locking ring may be configured so that the connector on the locking ring fits within the connector on the outer sleeve. In other words, the locking ring may be configured with an external flange and a circumferential groove that connect with an internal flange and annular groove within the outer sleeve.

Configured as described above, the mounting device 20 operates as follows. The device 20 is mounted onto a first element, such as a shaft 15, by sliding the device over the shaft so that the shaft slides through the inner bore of the inner sleeve 30 and the bore of the locking ring 40. The mounting device 20 is then fixed to the shaft by turning the locking ring.

Turning the locking ring 40 displaces the inner sleeve 30 relative to the outer sleeve 50. Referring to FIG. 4, a wedging action between the inner and outer sleeves is provided by displacing the inner sleeve rearward relative to the outer sleeve. Specifically, when the device is in a loosened position, the inner sleeve 30 is located within the outer sleeve 50 so that the major diameter of the inner sleeve frustoconical portion 34 is positioned within a portion of the outer sleeve bore having a diameter that is at least as great as the major diameter of the inner sleeve frustoconical portion. In other words, in the loosened position, the inner sleeve 30 does not contact the bore of the outer sleeve to provide a wedging or clamping force.

Rotating the locking ring 40 in a forward direction displaces the inner sleeve 30 rearwardly relative to the outer sleeve 50 so that the tapered surface of the frustoconical portion of the inner sleeve is displaced through the inner tapered bore of the outer sleeve. Driving the inner sleeve toward the smaller diameter deflects the inner sleeve radially inwardly so that the inner sleeve contracts to lock the inner sleeve onto the shaft. To release the connection between the mounting device and the shaft, the locking ring is simply rotated in a reverse direction. The reverse rotation displaces the inner sleeve away from the minor diameter of the tapered internal surface of the outer sleeve, which in turn releases the wedging force provided by the interfering tapered surfaces. In this way, rotating the locking ring in the reverse direction loosens the inner sleeve from the shaft.

A second element, such as a paper core 12 is mounted onto the shaft 15 by sliding the paper core over the shaft and then over the mounting device 20 so that the engaging surface 53 of the outer sleeve 50 protrudes into the bore 13 of the paper core. In one embodiment, the engaging surface 53 is inserted into the paper core until the internal surface 13 of the paper core engages the circumference of the engaging surface. More specifically, the paper core bore 13 engages a substantially continuous circumferential surface of the engaging surface 53.

A second mounting device 20a is mounted onto the shaft 15 adjacent the opposite end of the paper core 12. The second mounting device is positioned against the paper core, so that the engaging surface 53a of the outer sleeve 50a of the second device protrudes into the opposite end of the paper core in a manner similar to how the first mounting device 20 engages the first end of the paper core. The second mounting device 20a is then tightened onto the shaft by turning the locking ring 40a. In this way, the paper core 12 is supported at it ends by the two mounting devices 20, 20a positioned at opposite ends of the paper core.

The mounting devices 20, 20a may be positioned at opposite ends of the paper core 12 to provide a frictional lock between the mounting devices and the paper core. Specifically, the paper core 12 may be wedged between the two mounting devices so that the engaging surfaces 53, 53a of the mounting devices frictionally engage the paper core to substantially impede rotation of the paper core relative to the shaft. More specifically, after tightening the first mounting device 20 to lock the mounting device onto the shaft, the second mounting device 20a may be forced against the second end of the paper core 12 to wedge the paper core between the two mounting devices. In such an application, it may be desirable to form the engaging surface of a material having a relatively high coefficient of friction, such as polyurethane or other plastic material having a coefficient of friction greater than approximately 1.0. Alternatively, the mounting devices 20, 20a may be spaced apart from one another a sufficient distance to limit the frictional force between the engaging surfaces of the mounting devices 20, 20a and the paper core 12. The spacing of the mounting devices allows the paper core to readily rotate relative to the mounting devices 20, 20a and the shaft, while still being located and/or supported by the mounting devices. In an application in which it is desirable to allow rotation of the paper core relative to the mounting devices, it is desirable to form the mounting devices, and particularly the engaging surface 53 of the outer sleeve 50, from a material having a relatively low coefficient of friction, such as a high molecular weight plastic having a coefficient of friction less than approximately 1.0.

In an alternative embodiment, the outer sleeve has an external surface that has a diameter larger than the bore of the paper core 12. For instance, the outer sleeve may have a cylindrical external surface that is larger than the bore of the paper core. Such a mounting device can be used to position an element, such as a paper core, onto the shaft, while allowing the element to readily rotate relative to the shaft. In such an application, the outer sleeve abuts the end of the paper core, so that the paper core is located between two mounting devices that limit the axial displacement of the paper core. More specifically, the outer sleeve of a first mounting device abuts the face of the first end of the paper core, while the outer sleeve of a second mounting device abuts the face of the second end of the paper core.

It will be recognized by those skilled in the art that changes or modifications can be made to the above-described embodiments without departing from the broad inventive concept of the invention. For instance, in the above description, the embodiment was described as having a threaded inner sleeve 30 that threadedly engages the locking ring 40 to effect displacement of the inner sleeve relative to the outer sleeve 50. In another embodiment, the outer sleeve may incorporate a threaded portion rather than the inner sleeve. In such an embodiment, the inner sleeve would preferably include a connector to connect the inner sleeve to the locking ring to impede relative axial displacement between the locking ring and the inner sleeve, while allowing relative circumferential displacement of the locking ring relative to the inner sleeve. It should therefore be understood that this invention is not limited to the particular embodiments described herein but is intended to include all changes and modifications that are within the scope and spirit of the invention as set forth in the following claims.

1. A mounting device for mounting an element on a shaft, comprising:
an outer sleeve having an internal bore having a tapered portion and a frustoconical external surface, wherein the outer sleeve is substantially solid to prevent expansion or contraction when the device is tightened or loosened;
an inner sleeve comprising:
an internal bore;
a threaded portion;
an external tapered portion configured to cooperate with the tapered portion of the outer sleeve;
an axially elongated slot extending along the sleeve to allow expansion and contraction of the inner sleeve;
a locking ring threadedly engaging the threaded portion of the inner sleeve;
wherein turning the locking ring in a first direction operates to displace the inner sleeve in a first direction relative to the outer sleeve so that the external tapered portion of the inner sleeve rides up the internal tapered surface of the outer sleeve, causing the internal bore of the inner sleeve to contract, thereby tightening the device.

2. The mounting device of claim 1 wherein turning the locking ring in a second direction opposite the first direction operates to displace the inner sleeve in a second direction relative to the outer sleeve so that the external tapered portion of the inner sleeve rides down the internal tapered portion of the outer sleeve allowing the internal bore of the inner sleeve to expand, thereby loosening the device.

3. The mounting device of claim 1 wherein at least one of the inner sleeve and the outer sleeve is formed of plastic.

4. The mounting device of claim 1 wherein the frustoconical engagement surface of the outer sleeve is formed of a plastic having a coefficient of friction of at least 1.0.

5. The mounting device of claim 1 wherein the frustoconical engagement surface of the outer sleeve is formed of a plastic having a coefficient of friction of less than 1.0.

6. The mounting device of claim 1 wherein the inner sleeve comprises a plurality of axial slots extending through the inner sleeve along the tapered portion.

7. The mounting device of claim 1 wherein the forward end of the outer sleeve has a reduced diameter opening having a diameter that is smaller than the outer diameter of the forward end of the inner sleeve.

8. The mounting device of claim 1 comprising a connector connecting the outer sleeve and the locking ring to impede relative axial displacement between the outer sleeve and the locking ring, while allowing relative circumferential displacement between the locking ring and the outer sleeve.

9. A mounting device, comprising:
an outer sleeve having a generally frustoconical external engagement surface and an internal bore having a diameter;
a radially deformable inner sleeve comprising an internal bore and configured to cooperate with the bore of the outer sleeve to affect contraction of the inner sleeve bore;
one of the outer sleeve and inner sleeve having a threaded portion;
the other of the outer sleeve and the inner sleeve having a first connector;
a locking ring comprising: a threaded portion configured to threadedly engage the threaded portion of the one sleeve, and a second connector configured to cooperate with the first connector to connect the locking ring with the other sleeve to prevent substantial relative axial displacement between the locking ring and the other sleeve;
wherein the outer sleeve is configured to impede expansion of the engagement surface when the device is tightened by turning the locking ring in a first direction, which causes displacement of the inner sleeve relative to the outer sleeve.

10. The mounting device of claim 9 wherein the outer sleeve walls are substantially solid along the length of the engagement surface.

11. The mounting device of claim 9 wherein the outer sleeve bore comprises a portion having walls tapered and the external surface of the inner sleeve comprises a tapered portion configured to cooperate with the tapered bore of the outer sleeve.

12. The mounting device of claim 9 wherein the engagement surface of the outer sleeve is substantially rigid.

13. The mounting device of claim 9 wherein the inner sleeve comprises an axial slot.

14. The mounting device of claim 9 wherein the engagement surface is formed of a plastic material.

15. A method for mounting an elongated element having a generally cylindrical bore onto a shaft, comprising the steps of:
providing a first mounting device having an external sleeve with a tapered engagement surface, an inner sleeve and a locking ring;
providing a second mounting device having an external sleeve with a tapered engagement surface, an inner sleeve and a locking ring;
placing the elongated element onto the shaft so that the shaft extends through the bore of the elongated element;
positioning the first mounting on the shaft so that the tapered engagement surface engages the internal bore of the elongated element;
positioning the second mounting device on the shaft so that the tapered engagement surface engages the internal bore of the elongated element;
turning the locking ring of the first mounting device to contract the inner sleeve to thereby connect the inner sleeve to the shaft without expanding the outer sleeve of the first mounting device; and
turning the locking ring of the second mounting device to contract the inner sleeve to thereby connect the inner sleeve to the shaft without expanding the outer sleeve of the second mounting device.

16. The method of claim 15 comprising the step of spacing the second mounting device apart from the first mounting device a sufficient distance to allow the elongated element to rotate relative to the first and second mounting devices.

17. The method of claim 15 comprising the step of rotating the elongated element relative to the shaft while the first and second mounting devices are tightened to the shaft.

18. The method of claim 15 comprising the step of forcing the second mounting device against an end of the elongated element after the step of turning the locking ring of the first mounting device, to thereby wedge the elongated element between the first and second mounting devices to provide a frictional connection between the elongated element and the first and second mounting devices to impede rotation of the elongated element relative to the shaft.

19. The method of claim 15 wherein the bore of the outer sleeve of each of the first and second mounting devices comprises a minor diameter and the inner sleeve of each of the first and second mounting devices comprises a tapered surface having a major diameter that is larger than the minor diameter of the corresponding outer sleeve, wherein the steps of turning the first and second locking rings operates to displace the major diameter of each inner sleeve relative to the corresponding outer sleeve, toward the minor diameter of the corresponding outer sleeve thereby wedging the inner sleeves radially inwardly.

20. The method of claim 15 wherein the locking ring of the first mounting device threadedly engages one of the inner and outer sleeves of the first mounting device and is connected with the other of the inner and outer sleeve of the first mounting device.

21. A method for mounting an elongated element having a generally cylindrical bore onto a shaft, comprising the steps of:
providing a first mounting device having an outer sleeve with a tapered internal surface, an inner sleeve having a tapered external surface and a locking ring;
providing a second mounting device having an outer sleeve with a tapered internal surface, an inner sleeve having a tapered external surface and a locking ring;
placing the elongated element onto the shaft so that the shaft extends through the bore of the elongated element;
positioning the first mounting on the shaft so that the outer sleeve engages a first end face of the elongated element;
positioning the second mounting device on the shaft so that the outer sleeve engages a second end face of the elongated element;
turning the locking ring of the first mounting device to contract the inner sleeve to thereby connect the inner sleeve to the shaft without expanding the outer sleeve of the first mounting device; and
turning the locking ring of the second mounting device to contract the inner sleeve to thereby connect the inner sleeve to the shaft without expanding the outer sleeve of the second mounting device.

22. The method of claim 21 comprising the step of spacing the second mounting device apart from the first mounting device a sufficient distance to allow the elongated element to rotate relative to the first and second mounting devices.

23. The method of claim 21 comprising the step of rotating the elongated element relative to the shaft after the first and second mounting devices are tightened to the shaft.

24. The method of claim 21 wherein the bore of the outer sleeve of each of the first and second mounting devices comprises a minor diameter and the inner sleeve of each of the first and second mounting devices comprises a tapered surface having a major diameter that is larger than the minor diameter of the corresponding outer sleeve, wherein the steps of turning the first and second locking rings operates to displace the major diameter of each inner sleeve relative to the corresponding outer sleeve, toward the minor diameter of the corresponding outer sleeve thereby wedging the inner sleeves radially inwardly.

25. The method of claim 21 wherein the locking ring of the first mounting device threadedly engages one of the inner and outer sleeves of the first mounting device and is connected with the other of the inner and outer sleeve of the first mounting device.

26. A mounting device for mounting an element having an internal bore onto a shaft, comprising:
an outer sleeve having an outer diameter greater than the internal bore of the element, and an internal bore having a tapered surface;
a radially deformable inner sleeve comprising an internal bore and configured to cooperate with the bore of the outer sleeve to affect contraction of the inner sleeve bore;
one of the outer sleeve and inner sleeve having a threaded portion;
the other of the outer sleeve and the inner sleeve having a first connector;
a locking ring comprising: a threaded portion configured to threadedly engage the threaded portion of the one sleeve, and a second connector configured to cooperate with the first connector to connect the locking ring with the other sleeve to prevent substantial relative axial displacement between the locking ring and the other sleeve;
wherein the outer sleeve is substantially rigid to impede expansion of the outer sleeve when the device is tightened by turning the locking ring in a first direction, which causes displacement of the inner sleeve relative to the outer sleeve.

27. The mounting device of claim 26 wherein the outer sleeve bore comprises a portion having walls tapered and the external surface of the inner sleeve comprises a tapered portion configured to cooperate with the tapered bore of the outer sleeve.

28. The mounting device of claim 26 wherein the inner sleeve comprises an axial slot.

29. The mounting device of claim 9 wherein the outer sleeve is formed of a plastic material.
